(19) United States
(12) Patent Application Publication
(10) Pub. No.: US 2010/0270262 A1
(43) Pub. Date: Oct. 28, 2010

(54) ETCHING LOW-K DIELECTRIC OR REMOVING RESIST WITH A FILTERED IONIZED GAS

(75) Inventors: Hiroji HANAWA, Sunnyvale, CA (US); Kartik Ramaswamy, San Jose, CA (US)

Correspondence Address: Ashok K. Janah, 650 DELANCEY STREET, SUITE 106, SAN FRANCISCO, CA, 94107, US

(73) Assignee: APPLIED MATERIALS, INC., Santa Clara, CA (US)

(21) Appl. No.: 12/765,855

(22) Filed: Apr. 22, 2010

Related U.S. Application Data
(60) Provisional application No. 61/214,444, filed on Apr. 22, 2009.

(51) Int. Cl. C23F 1/02; H01B 13/00

(52) U.S. Cl. 216/13; 134/1.1; 156/345.48

(57) ABSTRACT

A method of etching a low-k dielectric on, or removing resist from, a substrate. In the method, the substrate is placed in a process zone. An ionized gas is generated in a gas ionization zone above the process zone, by introducing a process gas into a gas ionization zone, maintaining the process gas at a pressure of less than about 0.1 mTorr, and coupling RF energy to the process gas to form an ionized gas. The ionized gas is passed through an ion filter to form a filtered ionized gas. The substrate is exposed to the filtered ionized gas to etch the low-k dielectric layer on the substrate or to remove or clean remnant resist on the substrate.

### CROSS-REFERENCE

Under 35 U.S.C.§119(e), the present application claims the benefit of the filing date of Provisional Application No. 61/214,444 filed on Apr. 22, 2009, entitled “Etching and Cleaning a Low-K Dielectric with a Filtered Energized Gas”, which is incorporated by reference herein in its entirety.

### BACKGROUND

Embodiments of the present invention relate to the etching of a low-k dielectric material on a substrate during the fabrication of electronic or other structures on the substrate.

In the fabrication of electronic circuits, which include microelectronic circuits, solar panels, and displays, various features are fabricated on a substrate. For example, electrical interconnect lines are formed by depositing an electrical conductor material on the substrate, forming a patterned resist layer of etch-resistant material on the conductor, etching the conductor to form the interconnect lines, and depositing a dielectric layer over the etched interconnect lines. In some devices, a low-k dielectric material is used. Low-k dielectric materials have a dielectric constant or “k” value that is lower than conventional dielectric materials, such as silicon oxide, and typically have a “k” value of less than about 3. Low-k dielectric layers reduce the RC delay time in an integrated circuit allowing an increase in interconnect density. After deposition, the low-k dielectric layer can be etched to form vias or trenches that expose the underlying metal-containing conductor material or other substrate regions, respectively. After the etching process, remnant resist material is removed or cleaned off the substrate. Thereafter, electrically conducting material can be deposited into the etched holes to electrically contact the underlying conductor material.

However, conventional trench and via etching processes, as well as conventional remnant resist cleaning processes, often alter or change the dielectric value of the low-k dielectric material. For example, certain etching or resist cleaning process use a capacitively coupled plasma of an etching gas formed in a process zone containing the substrate that includes oxygen and one or more of N₂, H₂O, or CF₄. Still other etching and cleaning processes use dissociated or atomic oxygen produced upstream of the chamber, such as remotely dissociated microwave energized process gas, which is then released into the process zone of the chamber. Such processes, when used for either etching or cleaning the low-k dielectric layer, were often found to result in an increase in the dielectric constant of a low-k dielectric or cause damage to sensitive underlying substrate materials. For example, in some of these processes, the dielectric constant was found to increase from values around 2.7 to values as high as around 4. Changing the dielectric constant of the low-k dielectric material during the etching or cleaning process is undesirable and creates a problem in the fabrication of circuits and panels that use low-k dielectric materials.

For reasons that include these and other deficiencies, and despite the development of various apparatus and etching and cleaning processes for low-k dielectric materials, further improvements in such apparatus and processes are continuously being sought.

### SUMMARY

In a method of etching a low-k dielectric on a substrate or removing resist from the substrate, the substrate is placed in a process zone. An ionized gas is generated in a gas ionization zone by introducing a process gas into the gas ionization zone, maintaining the process gas at a pressure of less than about 0.1 mTorr, and coupling RF energy to the process gas to ionize the process gas to form the ionized gas. The ionized gas is passed through an ion filter to form a filtered ionized gas. The substrate is exposed to the filtered ionized gas.

In another version, a low-k dielectric on a substrate is etched and remnant resist on the low-k dielectric is removed. The substrate is placed in a process zone. An ionized gas is generated in a gas ionization zone by: (i) introducing a process gas comprising an oxygen-containing gas into the gas ionization zone; (ii) maintaining the process gas at a pressure of from about 0.01 mTorr to about 0.1 mTorr; and (iii) coupling RF energy to the process gas to ionize the process gas to form an ionized gas having a first ratio of ionized oxygen species. The ionized gas is passed through an ion filter to form a filtered ionized gas having a second ratio of ionized oxygen-containing species. The substrate is exposed to the filtered ionized gas.

A process chamber comprises a substrate support in a process zone. A gas distributor is provided to introduce a process gas into a gas ionization zone, the gas ionization zone being above the process zone. A gas ionizer couples energy to the process gas in the gas ionization zone to ionize the process gas. An ion filter forms ion beams from the ionized gas in the gas ionization zone and introduces the ion beams into the process zone. An ion filter power supply is provided to apply a voltage bias to the ion filter. An exhaust conduit is provided to exhaust spent process gas from the chamber.

### DRAWINGS

These features, aspects, and advantages of the present invention will become better understood with regard to the following description, appended claims, and accompanying drawings, which illustrate examples of the invention. However, it is to be understood that each of the features can be used in the invention in general, not merely in the context of particular drawings, and the invention includes any combination of these features, where:

FIG. 1A is a schematic sectional view of an embodiment of an process chamber comprising an ion filter;

FIG. 1B is a partial top view of an ion filter comprising a wire grid mounted on a gas distribution plate;

FIG. 2A-2D are schematic sectional views of a low-k dielectric layer on a substrate at various stages of processing, where FIGS. 2A and 2B show forming a patterned resist layer over a low-k dielectric layer on a substrate, FIG. 2C shows the substrate of FIG. 2A after etching of the low-k dielectric layer to form feature comprising an etched void, and FIG. 2D shows the substrate after removal of the remnant resist;

FIG. 3 is a schematic view of a multi-chamber system; and

FIG. 4 is an illustrative block diagram of a controller comprising a computer readable program to operate the process chamber of FIG. 1A.

### DESCRIPTION

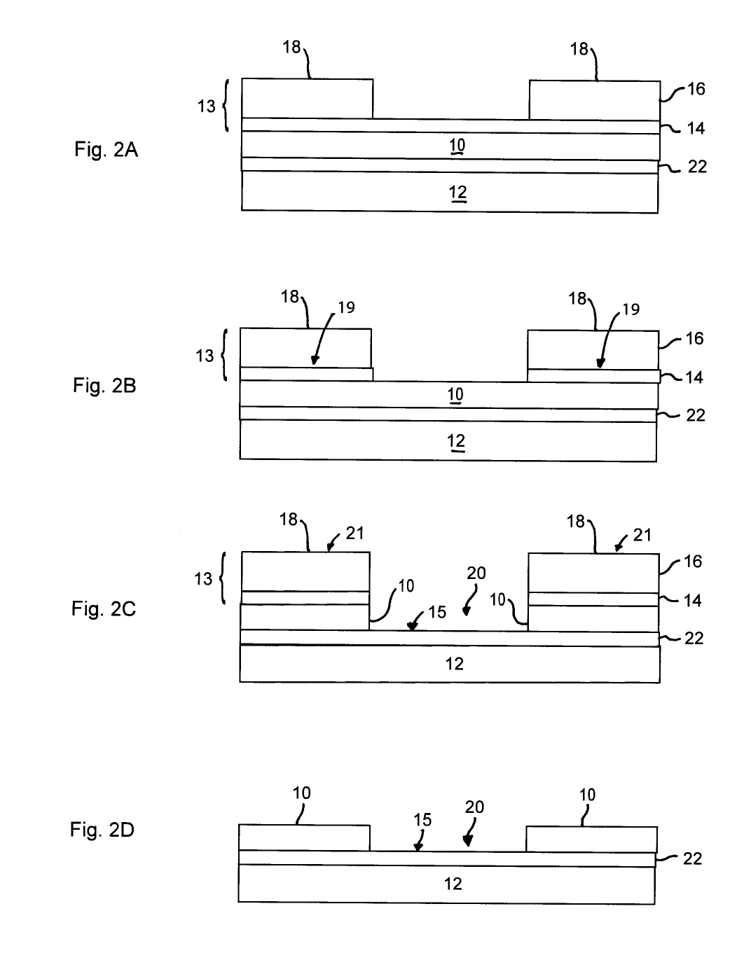

A low-k dielectric 10 on a substrate 12 is etched, and/or resist 13 is removed from a substrate, as shown in the exemplary process flow embodiments of FIGS. 2A to 2D. The substrate 12 can be made of a material such as glass, ceramic, metal, polymer, or semiconductor material, such as silicon or gallium arsenide. In one version, the substrate 12 comprises a semiconductor material, such as silicon, polycrystalline silicon, germanium, silicon germanium, or a compound semiconductor. A silicon wafer can have single or large crystals of silicon, and an exemplary compound semiconductor comprises gallium arsenide. The substrate 12 can also include a layer of semiconductor material which can be doped or undoped, metal layers or features, or other materials. For example, a substrate 12 comprising a dielectric material, such as a panel or display, can have a layer of semiconductor material deposited thereon to serve as the active semiconducting layer of the substrate 12. Suitable dielectric materials include, for example, borophosphosilicate glass, phosphosilicate glass, borosilicate glass and phosphosilicate glass; polymeric materials, and other materials.

The low-k dielectric 10 on the substrate 12 comprises a dielectric material having a k value of less than about 3, such as from about 2 to about 3, and even a k value of less than about 2.7. For example, a suitable low-k dielectric can be Black Diamond™, a low-k silicon oxycarbide fabricated by Applied Materials, Inc., Santa Clara, Calif. Other suitable low-k dielectric materials comprise combinations of silicon with at least one of oxygen, carbon, hydrogen and other elements. For example, the low-k dielectric 10 can comprise an organic polymer material having a low dielectric constant, such as benzocyclobutene, parylene, polytetrafluoroethylene, polyether, polyimide, or mixtures thereof, or can even comprise an organic polymer material having a low dielectric constant and including small amounts of other materials to provide increased thermal stability and/or adhesion to a variety of metals and oxides. As another example, the low-k dielectric layer can comprise a silicon-containing organic polymer material having a low dielectric constant, such as benzocyclobutene. By silicon-containing it is meant that the organic polymer material contains elemental silicon or silicon compounds, such as Si, SiO₂, or Si₃N₄. The low-k dielectric 10 can be provided as a layer or in other configurations.

In one embodiment, a low-k dielectric 10 comprising an organic polymer material is generally fabricated from high viscosity fluids consisting essentially of an organic polymer-precursor suspended in a solvent base. For example, CYCLOTENE®, manufactured by Dow Chemical Company, comprises the organic polymer benzocyclobutene, which has a dielectric constant of about 2.4 and is suspended in a solvent. The fluid polymer-precursor is applied on a substrate 12 using a conventional spin-coating apparatus (not shown) to form a low-k dielectric 10 comprising an organic polymer. The thickness of the low-k dielectric 10 is adjusted by varying the volume of polymer dispensed on the substrate 12, the speed at which the substrate 12 is spun, i.e., the spinning time. The polymer layer on the substrate 12 is then cured in a vacuum oven in a low pressure and/or high temperature environment, to evaporate the solvent carrier and cross-link the polymer.

A resist 13 is provided over the low-k dielectric 10, the resist 13 being a single layer or a combination of layers which are etch-resistant as shown in FIG. 2A. In one version, the resist 13 comprises a hard mask layer 14, such as for example, silicon oxide, silicon nitride, silicon oxy-nitride, sputtered silicon, amorphous silicon, or amorphous carbon. The hard mask layer 14 is deposited directly over the low-k dielectric 10 by any conventional means, including plasma enhanced vapor deposition, chemical vapor deposition, and physical vapor deposition. An exemplary hard mask layer 14 comprises, for example, a layer of silicon dioxide deposited by CVD to a thickness of about 0.1-0.3 micron.

The hard mask layer 14 is patterned and etched to define the mask features 19 as shown in FIG. 2B, using conventional photolithographic processes. In one photolithographic process, a photoresist layer 16 (for example, RISTON®, manufactured by DuPont de Nemours Chemical Company) is applied on the hard mask layer 14, and resist features 18, such as holes or voids for forming vias, are etched by exposing the photoresist layer 16 to a pattern of light through a mask having a pattern corresponding to the desired configuration of resist features 18; treating the light-exposed photoresist layer 16 using a developer and the unexposed resist removed to form the resist features 18 which expose uncovered portions of the hard mask layer 14. This allows the mask layer 14 to be etched using conventional etching processes, such as a plasma or energized process gas comprising a fluorine-containing gas, to expose portions of the underlying low-k dielectric 10, as shown in FIG. 2B.

Thereafter, an etching process is performed to etch the low-k dielectric 10 on the substrate 12 to form features 20 therein that expose the surface 15 of underlying layers as shown in FIG. 2C. For example, the low-k dielectric layer can be etched to expose an underlying layer, such as a layer of metal-containing conductor 22. The etching process removes portions of the low-k dielectric 10 from the surface 15 of the underlying metal-containing conductor 22 to create features 20 comprising contact holes (or trenches) into which are later deposited additional materials, such as electrically conductive materials, to establish electrical contact between the surface 15 and features of overlying layers (not shown). For example, the features 20 can be filled with a metal-containing material to form a contact hole which connects an underlying metal-containing feature to an overlying metal-containing feature.

After the etching process, a remnant resist removal or cleaning process is performed to remove the remnant resist 21 which remains over the low-k dielectric 10. The remnant resist 21 includes portions of the photoresist layer 16 and/or mask layer 14 that remains after a surface and sidewall portion of at least the photoresist layer 16 is at etched away during the etching process performed for the low-k dielectric 10. Thus, the remnant resist 21 can include a residual portion of the original thickness of the photoresist layer 16 of the resist 13. The residual photoresist layer 16, and thereafter, other underlying portions, such as the mask layer 14 of the resist 13 that can remain on the substrate 12 after the low-k dielectric etching process, is removed during this step. Advantageously, the same process gas can be used to remove the residual photoresist portion of the resist features 13 as that used to etch the low-k dielectric 10 as explained below.

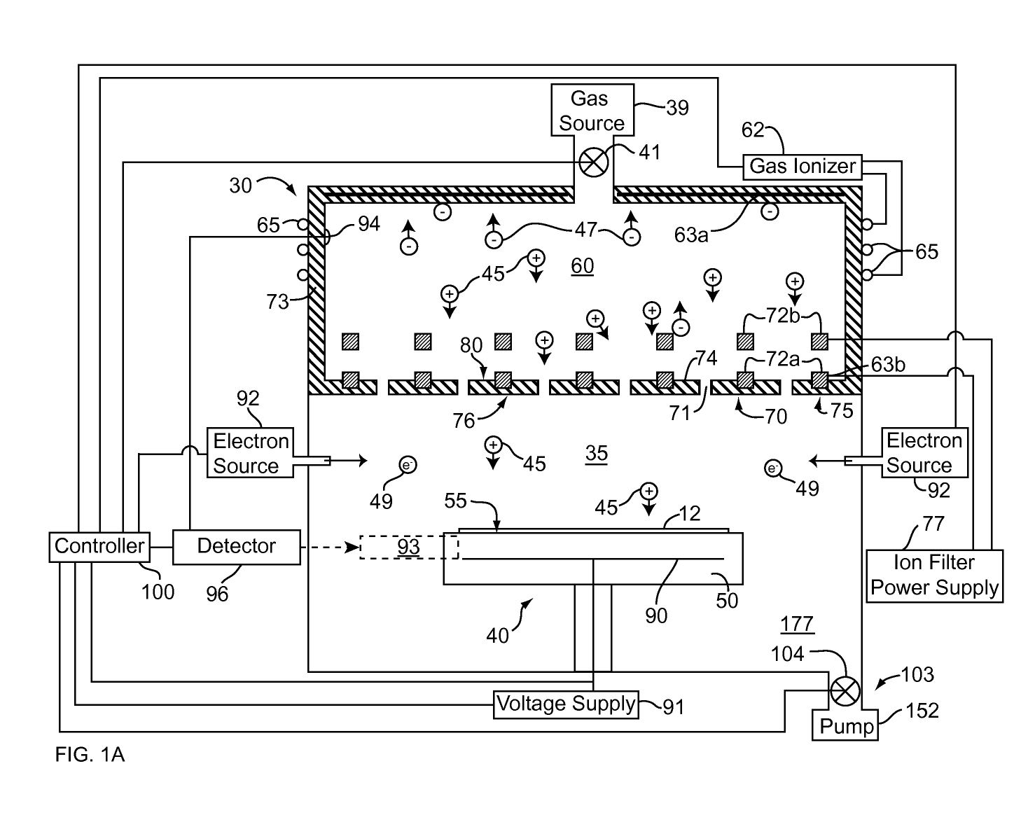

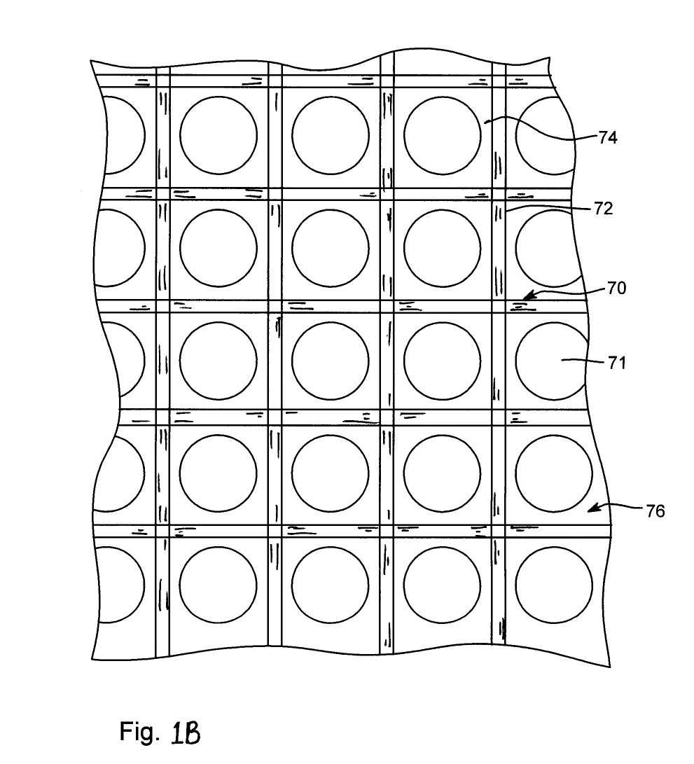

The low-k dielectric etching process and/or remnant resist removal and cleaning process, can be performed in a process chamber 30, an embodiment of which is shown schematically in FIG. 1A. The process chamber 30 comprises sidewalls, ceiling, lower wall which enclose a process zone 35 to allow the process zone 35 to be maintained at sub-atmospheric pressures. A suitable process chamber 30 for processing of semiconductor substrates is, for example, a DIELECTRIC ETCH MxP+ CENTURA chamber, available from Applied Materials Inc., Santa Clara, Calif. The particular embodiment of the process chamber 30 shown herein is provided only to illustrate certain aspects of the invention and should not be used to limit the scope of the invention. Other process chambers capable of generating an ionized process gas in a remote zone and providing an ion beam or shower of ions to the process zone 35 can also be used, such as for example, an IPS-type chamber which is also available from Applied Materials Inc.

To perform the process, the process chamber 30 is evacuated and a substrate 12 is placed in the process zone 35 of the chamber 30. The substrate 12 is placed on a substrate support 40. In one embodiment, the substrate 12 is held in place during the etching process using a mechanical or electrostatic chuck 50 having a receiving surface 55 with grooves in which a coolant gas, such as helium, is held to control the temperature of the substrate 12.

Process gas from a gas source 39 is introduced into a gas ionization zone 60 through a gas distributor 73 having a gas distribution plate 76 with apertures 71. The gas distributor 73 encloses a gas ionization zone 60. During the process, the process chamber 30 can be maintained at a pressure of less than about 0.1 mTorr, and in one version, at least about 0.01 mTorr. Conventional plasma processes typically cannot be sustained at such low pressures as the plasma fails to ignite or is extinguished during processing. The present apparatus overcome this difficulty by ionizing the process gas using a gas ionizer 62, and thereafter, forming ion beams from a filtered ionized gas. The ion beams formed from the filtered ionized gas etches a low-k dielectric 10 and/or removes remnant resist 21, such as residual photoresist layer 16 from the surface of the low-k dielectric 10 without damaging the low-k properties of the dielectric or the properties of the underlying material, underlying layers, substrate, or doped portions of the substrate 12.

The process gas is ionized in the gas ionization zone 60 by a gas ionizer 62 which couples energy, such as RF energy, to the process gas in the gas ionization zone 60, as shown in FIG. 1A, to form a remotely ionized gas comprising dissociated species such as positive and negative ions, and even electrons. For example, the gas ionizer 62 can cause an electric field to be coupled to the process gas to ionize and energize the process gas in any of the following manners: (i) inductively, by applying an RF current to an inductor coil 65 encircling the process chamber 30, (ii) capacitively, by applying an RF current to ionizer electrodes 63a,b that are separated across the gas ionization zone 60, or (iii) both inductively and capacitively.

In the version shown in FIG. 1A, the gas ionizer 62 comprises an upper ionizer electrode 63a is about or embedded in an upper wall of the gas ionization zone 60, and a lower ionizer electrode 63b is about, or mounted on, a lower wall enclosing the gas ionization zone 60. While an exemplary electrode configuration is shown to illustrate the principles of the present apparatus, other electrode configurations, or even additional types or alternative positions of the electrodes can be used. In one version, the process gas is ionized by capacitively coupling an RF voltage at a power level of from about 50 to about 11000 watts, or even from about 100 to about 2000 watts, between a cathode electrode, such as the electrode 63b, and an electrically grounded anode electrode, such as the electrode 63a. In one version, the RF voltage is applied to the electrodes by an electrode voltage supply 91, and can be, for example, from about 10 to about 12000 volts. Alternatively, an RF current at a power level of from about 750 watts to about 2000 watts can be applied to an inductor coil 65 to inductively couple energy into the process chamber 30 to ionize the process gas in the gas ionization zone 60. The frequency of the RF current applied to the process electrodes 63a,b or inductor coil 65 can be from about 50 KHz to about 60 MHz, or even about 13.56 MHz.

In one version, the ionized gas is formed from a process gas comprising an oxygen-containing gas, such as oxygen, and other components such as fluorine-containing gases. The flow rate of the process gas during processing is dependent on the size of the process zone 35 and should be sufficiently high to react with substantially all the etchant residue on the substrate 12 to form gaseous byproducts. However, excessively high flow rates can cause isotropic etching of the low-k dielectric layer, which is undesirable. For a process zone 35 having a volume of about 10,000 cm³, a suitable flow rate of oxygen gas is about 5 to about 100 sccm, or even from about 10 to about 40 sccm. For different sized process chambers 30, equivalent flow rates of oxygen that maintain substantially the same ratio of oxygen flow in sccm to process chamber volume in cm³ should be used. The process gas can also include a fluorine-containing gas, such as for example, one or more of a carbon-fluorine gas or sulfur-fluorine gas, such as CF₄ or SF₆. In one version, a volumetric flow rate of the fluorine-containing gas is at least 1 sccm, and can even be less than 10 sccm, for example, from about 1 to about 10 sccm.

The process gas can further include an inert or nonreactive gas, such as N₂, Ar, He, Xe and Kr. The inert or nonreactive gas promotes ion bombardment to increase process gas collisions and reduce recombination of ion species. The flow rate of the inert or non-reactive gas can be from about 10 sccm to about 1200 sccm, such as between about 5 sccm and about 1000 sccm.

Spent process gas and etchant byproducts are exhausted from the process chamber 30 through an exhaust conduit 177 and an exhaust system 103. The exhaust system 103 comprises an exhaust pump 152 that is capable of achieving a minimum pressure of about 10⁻³ mTorr in the process chamber 30. A throttle valve 104 is provided in the exhaust system 103 for controlling the pressure in the process chamber 30.

After ionization of the process gas in the gas ionization zone 60, the ionized gas is filtered using an ion filter 70 to form a filtered ionized gas comprising ion beams that correspond to the streams of gas through the apertures 71 of the gas distribution plate 76. The filtered ionized gas etches the low-k dielectric 10, and thereafter, removes remnant resist 21 from the surface of the low-k dielectric 10 without damaging the low-k layer or underlying substrate material. The gas ionization zone 60 is located a suitable distance away from a process zone 35 of the chamber 30 such that the ionized gas can be ionized in the gas ionization zone 60, and then filtered through the openings 74 of an ion filter 70 to pass through apertures 71 of a gas distribution plate 76 to form a filtered ionized gas having a controlled concentration or amount of ionic species in the process zone 35. In one version, the ionized process gas has a first ratio of ionized oxygen species, and after filtering, the filtered ionized gas has a second ratio of ionized oxygen-containing species. By way of example only, the value of the first ratio can be at least about 100 times the value of the second ratio, or even at least about 500 times the value of the second ratio.

The ion filter can have various configurations as would be apparent to those of ordinary skill in the art. In one version, the ion filter 70 comprises a pair of spaced apart and electrically conducting wire grids 72a,b, that each have openings 74 through which the ionized gas can pass, as shown in FIGS. 1A and 1B. The wire grids 72a,b are electrically biased by an ion filter power supply 77 to cause positively charged ionic species are accelerated downwards in the remote zone towards the wire grids. The wire grids 72a,b can also be biased to create an electric potential that repels negatively charged ionic species. The wire grids 72a,b comprise a ratio of the total area of the openings 74 of either one of the grids 72a,b to the total area covered by the solid portions of the same wire grid 72a,b, that is sufficiently high to allow a good flow of ions therethrough. A suitable ratio is from about 10:1 to about 1000:1, and even at least about 200:1. Each of the wire grids 72a,b is composed of a suitable electrically conducting material such as, for example, at least one of molybdenum, titanium, nickel-chromium alloy, and/or an aluminum alloy.

The wire grids 72a,b are placed in the flow path of the ionized gas between the gas ionization zone 60 and the substrate 12 on the substrate support 40—for example, the gas ionization zone 60 can be directly above the process zone 35. In one version, as shown in FIG. 1A and 1B, at least one of the wire grids 72a,b can be mounted on a gas distribution plate 76 that distributes the ionized gas received from the gas ionization zone 60 into the process zone 35. For example, the wire grid 72a can be mounted on the gas distribution plate 76 such that the openings 74 in the wire grid 72b coincide with apertures 71 in the gas distribution plate 76 to allow a flow of ionized gas through the wire grid 72a and gas distribution plate 76 to form a filtered ionized gas in the process zone 35. The wire grid 72a can even be at least partially embedded in the gas distribution plate 76 (as shown in FIG. 1A) to inhibit corrosion of the wire grid 72a. The wire grid 72a can also be free-standing or, alternatively, be mounted on a bottom surface 75 of the gas distribution plate 76 or otherwise spaced apart from the gas distribution plate 76. The other wire grid 72b can be mounted spaced apart from the wire grid 72a, for example, above a top surface 80 of the gas distribution plate 76. The gas distribution plate 76 desirably comprises a dielectric material, e.g., at least one of alumina, sapphire, silica and quartz, and can also comprise a conducting material, e.g., at least one of silicon, aluminum and silicon carbide.

The ion filter 70 controls the ion filter power supply 77 to set the kinetic energy and ion filtration characteristics of the ionic species of the ionized gas by controlling a DC potential applied to the wire grids 72a,b. For example, the ion filter 70 can set a voltage bias between the wire grids 72a,b that controllably accelerates a filtered set of (positively charged) ions 45 towards the wire grid 72b and then onwards to the substrate 12, while causing other (negatively charged) ions 47 (or electrons) to be directed towards the wire grid 72a. The ion filter power supply 77 can be set to apply an electrical potential or bias between the wire grids 72a,b that is at least about 10,000 volts, and even less than about 100,000 volts. The potential can even be applied with a sufficient level to decrease recombination of the positive and negative ionic species in the gas ionization zone 60 and provide a greater amount of positive ions 45 to the process zone 35. The combination of the gas ionizer 62, which provides a source of power to ionize the process gas, and the ion filter 70 that has a bias power serves to filter, further dissociate, and accelerate dissociated positive ions 45 toward the substrate 12.

In one version, the process chamber 30 has an electron source 92 which can be, for example, an electron gun. The electron source 92 is operated in conjunction with the ion beam to inject electrons 49 into the process zone 35 and prevent excessive charge accumulation on the substrate 12 or other surfaces in the chamber 30. The electron source 92 can comprise a wire filament through which a current is passed to heat the wire, which then ejects the electrons 49 into the chamber. An accelerating voltage can optionally be provided to flow the electrons 49 away from the filament and towards the process zone 35. The electron source 92 is positioned to inject the electrons 49 into the process zone 35. In one embodiment, the chamber 30 comprises a charge sensor 93 capable of measuring the charge accumulation on a surface in the chamber 30, e.g., on the surface of the substrate 12, and sending a charge signal to a detector 96 which can be a conventional charge-measuring device. The electron source 92 can be controlled in relation to a signal from the charge sensor 93 to maintain the substrate 12 or other chamber surface(s) at a neutral charge.

The etching process or resist cleaning process is performed with sufficient ion flux up to completion of the etching process. An optical endpoint measurement technique can be used to determine completion of the etching process for a specific layer by measuring the change in light emission intensity of a particular wavelength corresponding to a detectable gaseous species. A sudden decrease or increase in the amount of the detectable species, such as CO or CN, that results from chemical reaction of the process gas with the silicon dioxide or polysilicon layer indicates completion of etching of the dielectric layer and start of etching of the underlayer.

During the process for etching the low-k dielectric 10 or removing the remnants of the photoresist layer 16, the oxygen-containing gas reacts with carbon in the low-k dielectric 10 and/or the overlying photoresist layer 16 to form gaseous carbon-oxygen species. Advantageously, the etching and remnant resist or cleaning process exposes the substrate 12 to ionized heavy ions such as oxygen and fluorine ions. The heavy ions are ionized atomic species that have one unpaired electron and consequently, are highly chemically reactive, such as the aforementioned oxygen and fluorine atoms. It is believed that the heavy ionic species provide a relatively gentler etchant process by kinetically bombarding the surface of the low-k dielectric 10 to erode away portions of the low-k dielectric 10 without damaging the low-k dielectric properties of the material. Thus, heavy ionic species can interact or react with the exposed surface of the low-k dielectric 10 without undesirably damaging or chemically altering the structure and composition of the low-k dielectric 10. For example, the increase in the k value of the low-k dielectric 10 in the present ion beam etch process may be less than about 0.1, and even less than about 0.05.

A further advantage of the present process is that the filtered ionized gas can be used to both etch material and/or remove resist and etchant byproducts and any passivating deposits on the substrate 12. Further, the etching and cleaning processes may also be performed simultaneously without damaging the low-k dielectric 10, especially at low etching temperatures. Alternatively, when the etching of the low-k dielectric 10 is completed, a post-process of removing remnant resist 21 with the same or a different process gas composition can proceed immediately without interrupting the manufacturing process. In contrast to conventional remnant resist removal processes that require the substrate 12 to be heated to temperatures of from about 200 to about 400° C. in order to burn off the resist, the process of the present invention can be used to remove the remnant resist 21, such as photoresist, at relatively low temperatures.

While the present process is illustrated with an exemplary version in which both low-k dielectric 10 and remnant resist 21 are removed using the process, it should be understood the present resist removal process can be used by itself to remove remnant resist 21 from other structures which may or may not include a low-k dielectric 10. Thus, the present process should not be limited to the exemplary embodiments recited herein to the removal of remnant resist overlying low-k dielectric 10.

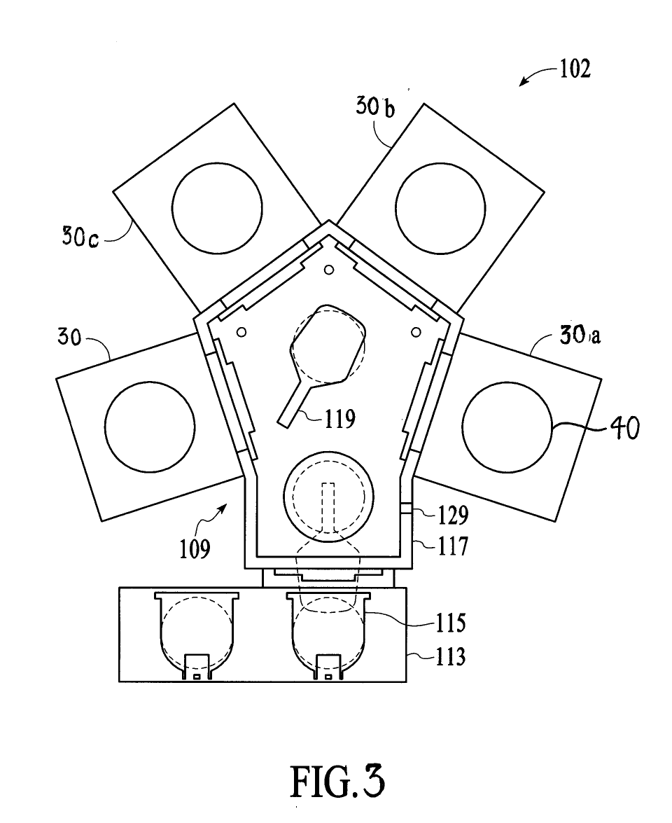

The apparatus comprising the process chamber 30 can also be a part of a larger multi-chamber apparatus 102 comprising a plurality of process chambers 30, 30a-c. An embodiment of an apparatus 102 suitable for processing substrates 12 comprises one or more processing chambers 30, 30a-c, as shown in FIG. 3. The chambers 30, 30a-c are mounted on a platform 109, such as a Precision 5000™ platform from Applied Materials, Inc., of Santa Clara, Calif., that provides electrical, plumbing, and other support functions. The platform 109 typically supports a load lock 113 to receive a cassette 115 of substrates 12 to be processed and a substrate transfer chamber 117 containing a robot 119 to transfer substrates from the cassette 115 to the different chambers 30, 30a-c for processing and return them after processing. The different chambers 30, 30a-c may include, for example, a deposit cleaning chamber 30a, a deposition chamber 30b for depositing materials on wafers, and optionally, a heat treatment chamber 30c, as well as other processing chambers. The chambers 30, 30a-c are interconnected to form a continuous vacuum environment within the apparatus 102 in which the process may proceed uninterrupted, thereby reducing contamination of substrates 12 that may otherwise occur when transferring wafers between separate chambers for different process stages. The transfer chamber 117 comprises an exhaust system 103 having an outlet 129 to exhaust gases and maintain a low pressure environment (e.g., a pressure of less than about 10 mTorr) in order to reduce contamination of the chambers 30, 30a-c.

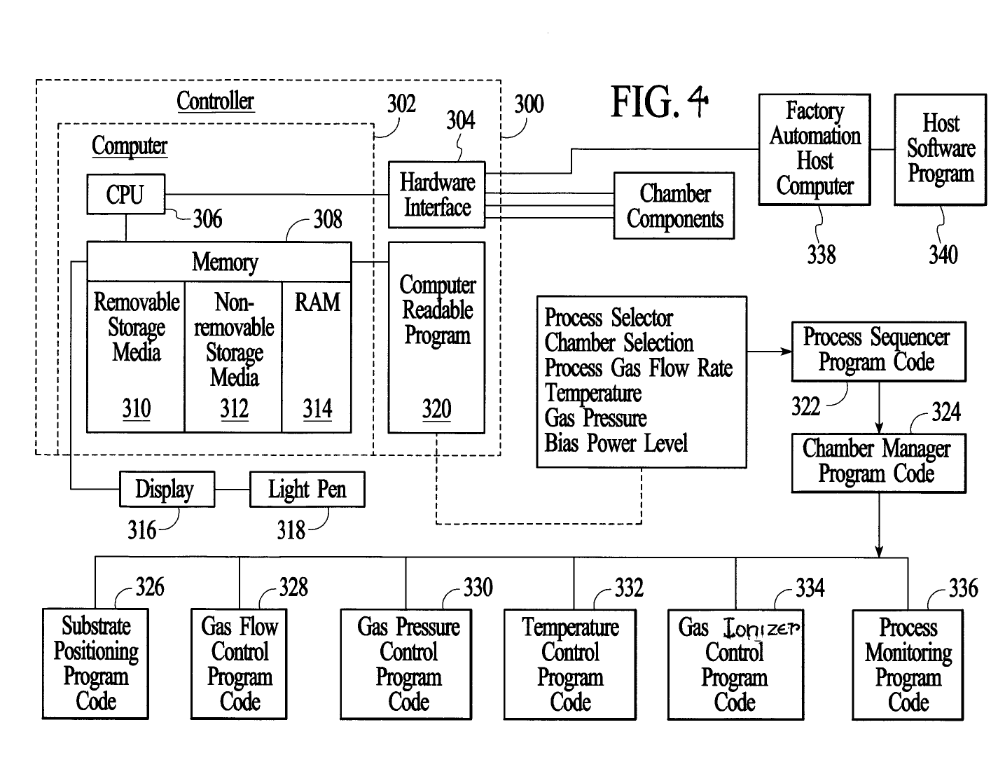

The multi-chamber apparatus 102 can be operated by a controller 300 via a hardware interface 304, as shown in FIG. 4. The controller 300 comprises a computer 302 having a central processor unit (CPU) 306 (such as a 68040 microprocessor, commercially available from Synergy Microsystems, Calif., or a Pentium Processor commercially available from Intel Corporation, Santa Clara, Calif.) that is coupled to a memory 308 and peripheral computer components. Preferably, the memory 308 may include a removable storage media 310 (e.g., a CD or floppy drive), a non-removable storage media 312 (e.g., a hard drive), and random access memory 314. The controller 300 may further comprise a plurality of interface cards including, for example, analog and digital input and output boards, interface boards, and motor controller boards. The interface between an operator and the controller 300 can be via a display 316 and user control interface 318, which can be any suitable control device such as a keyboard, mouse or light pen. A voltage supply 91 provides power to the controller 300, which the controller can use to power itself, and to power other components of the chamber 30 such as gas energizer, electron sources, and others.

In one version the controller 300 comprises a computer-readable program 320 may be stored in the memory 308—for example, on the non-removable storage media 312 or on the removable storage media 310. The computer readable program 320 generally comprises process control software comprising program code to operate the chambers 30, 30a-c and their components, the transfer chamber 117 and robot 119, process monitoring software to monitor the processes being performed in the chambers 30, 30a-c, safety systems software, and other control software. The computer-readable program 320 may be written in any conventional computer-readable programming language, such as assembly language, C++, or Fortran. Suitable program code is entered into a single file or multiple files using a conventional text editor and stored or embodied in a computer-usable medium of the memory 308. If the entered code text is in a high level language, the code is compiled, and the resultant compiler code is then linked with an object code of precompiled library routines. To execute the linked, compiled object code, the user invokes the object code, causing the CPU 306 to read and execute the code to perform the tasks identified in the program.

An illustrative block diagram of a hierarchical control structure of a specific embodiment of a computer-readable program 320 is shown in FIG. 4. Using a control interface 318, a user enters a process set and chamber number into the computer-readable program 320 in response to menus or screens on display 316. The computer-readable program 320 includes program code to control the substrate position, gas flow, gas pressure, temperature, RF power levels, and other parameters of a particular process, as well as code to monitor the chamber process. The process sets are predetermined groups of process parameters necessary to carry out specified processes. The process parameters are process conditions such as gas composition, gas flow rates, temperature, pressure, gas ionizer settings such as RF power levels.

The process sequencer program code 322 comprises program code to accept a chamber type and set of process parameters from the computer readable program 320 and to control its operation. The sequencer program code 322 initiates execution of the process set by passing the particular process parameters to a chamber manager program code 324 that controls multiple processing tasks in the process chamber 30, 30a-c. Typically, the process chamber program code 324 includes a substrate positioning program code 326, a gas flow control program code 328, a gas pressure control program code 330, a temperature control program code 332, a gas ionizer control program code 334, and a process monitoring program code 336.

Typically, the substrate positioning program code 326 comprises instructions for controlling chamber components that are used to load the substrate 12 onto the substrate support 40 in any one of the chambers 30, 30a-c, and optionally, to lift the substrate 12 to a desired height in the chamber 30, 30a-c. The substrate positioning program code 326 can also control the robot 119 in the transfer chamber 117 to transfer the substrate 12 between chambers 30, 30a-c in the multi-chamber apparatus 102. The gas flow control program code 328 comprises instructions for controlling the flow rates of different constituents of process gas, such as cleaning gas, heat treatment gas, or sputtering gas. The gas flow control program code 328 regulates the opening size of one or more gas flow valves 41 to obtain the desired gas flow rate into the chambers 30, 30a-c.

The temperature control program code 332 comprises program code for controlling temperatures in the chambers 30, 30a-c, such as the temperature of the substrate 12. For example, the temperature control program code 332 can control the temperature of a substrate 12 in a chamber 30, 30a-c by controlling a current applied to a heater 90, such as a resistance heating element in the substrate support 40, and monitoring a signal from a temperature sensor 94 to maintain a desired temperature. The temperature control program code 332 can similarly control the temperature of the substrate 12 in a separate heat treatment chamber 30b by controlling a current applied to a heater (not shown) such as radiant energy lamps in the chamber, and monitoring the substrate temperature. The gas ionizer control program code 334 comprises instructions for controlling gas ionizers, such as a gas energizer in the chamber or a remote gas energizer, e.g., by setting a power level applied to energize the gas. The process monitoring program code 336 comprises instructions for monitoring the process in the chambers 30, 30a-c, e.g., by monitoring a composition of the process gas to detect an endpoint in the chamber or monitoring the charge of the substrate 12 or chamber surfaces via a detector 96 which is connected to the controller and which receives a charge signal input from a charge sensor 93. The gas pressure control program code 330 comprises instructions for controlling the pressure in the chambers 30, 30a-c or in a transfer chamber 117, e.g., by controlling a throttle valve 104.

The data signals received by and/or evaluated by the controller 300 may be sent to a factory automation host computer 338. The factory automation host computer 338 may comprise a host software program 340 that evaluates data from several systems, platforms 109, or chambers 30, 30a-c (and for batches of substrates 12 or over an extended period of time) to identify statistical process control parameters of: (i) the processes conducted on the substrates 12, (ii) a property that may vary in a statistical relationship across a single substrate 12, or (iii) a property that may vary in a statistical relationship across a batch of substrates 12. The host software program 340 may also use the data for ongoing in situ process evaluations or for the control of other process parameters. A suitable host software program 340 comprises a WORKSTREAM™ software program available from aforementioned Applied Materials, Inc. A factory automation host computer 338 may be further adapted to provide instruction signals to (i) remove particular substrates 12 from the processing sequence (for example, if a substrate property is inadequate or does not fall within a statistically determined range of values, or if a process parameter deviates from an acceptable range); (ii) end processing in a particular chamber 30, 30a-c; or (iii) adjust process conditions upon a determination of an unsuitable property of the substrate 12 or process parameter. The factory automation host computer 338 may also provide the instruction signal at the beginning or end of processing of the substrate 12 in response to evaluation of the data by the host software program 340.

Although exemplary embodiments of the present invention are shown and described, those of ordinary skill in the art may devise other embodiments which incorporate the present invention and which are also within the scope of the present invention. For example, gases that are equivalent in function to the listed process gases or inert gases can also be used, and the etching process can be used to etch other layers or structures, such as passivation layers and stress-reducing layers. The chamber may comprise components other than those specifically described, as would be apparent to those of ordinary skill in the art. Furthermore, the terms below, above, bottom, top, up, down, first and second and other relative or positional terms are shown with respect to the exemplary embodiments in the figures and are interchangeable. Therefore, the appended claims should not be limited to the descriptions of the preferred versions, materials, or spatial arrangements described herein to illustrate the invention.

What is claimed is:

1. A method of etching a low-k dielectric on a substrate or removing resist from the substrate, the method comprising:
(a) placing a substrate in a process zone, the substrate having a low-k dielectric and resist thereon;
(b) generating an ionized gas in a gas ionization zone by introducing a process gas into the gas ionization zone, maintaining the process gas at a pressure of less than about 0.1 mTorr, and coupling RF energy to the process gas to ionize the process gas to form the ionized gas;
(c) passing the ionized gas through an ion filter to form a filtered ionized gas; and
(d) exposing the substrate in the process zone to the filtered ionized gas.

2. A method according to claim 1 wherein (b) comprises maintaining the process gas at a pressure of at least about 0.01 mTorr.

3. A method according to claim 1 wherein (b) comprises introducing a process gas comprising an oxygen-containing gas and a fluorine-containing gas.

4. A method according to claim 3 wherein in (b), the ionized gas has a first ratio of ionized oxygen species, and wherein (c) comprises filtering the ionized gas to form a filtered ionized gas having a second ratio of ionized oxygen-containing species.

5. A method according to claim 4 wherein the value of the first ratio is at least about 100 times the value of the second ratio.

6. A method according to claim 3 wherein (b) comprises introducing a fluorine-containing gas comprising a carbon-fluorine or sulfur-fluorine gas.

7. A method according to claim 1 wherein (c) comprises maintaining a pair of wire grids between the gas ionization zone and the process zone.

8. A method according to claim 7 wherein (c) comprises maintaining across the wire grids, an electrical bias of at least about 10,000 volts and less than about 100,000 volts.

9. A method according to claim 1 comprising introducing the process gas at a flow rate of at least 1 sccm and less than 10 sccm.

10. A method of etching a low-k dielectric on a substrate and removing remnant resist from the low-k dielectric, the method comprising:
(a) placing a substrate in a process zone, the substrate comprising a low-k dielectric and resist thereon;
(b) generating an ionized gas in a gas ionization zone by:
(i) introducing into the gas ionization zone, a process gas comprising (i) an oxygen-containing gas, and (ii) carbon-fluorine or sulfur-fluorine gas;
(ii) maintaining the process gas at a pressure of from about 0.01 mTorr to about 0.1 mTorr; and
(iii) coupling RF energy to the process gas to ionize the process gas to form an ionized gas having a first ratio of ionized oxygen species;
(c) passing the ionized gas through an ion filter to form a filtered ionized gas having a second ratio of ionized oxygen-containing species; and
(d) exposing the substrate to the filtered ionized gas.

11. A method according to claim 10 wherein the value of the first ratio is at least about 100 times the value of the second ratio.

12. A method according to claim 10 wherein a pair of wire grids is positioned between the gas ionization zone and the process zone, and wherein (c) comprises maintaining across the wire grids, an electrical bias of at least about 10,000 volts and less than about 100,000 volts.

13. A method according to claim 10 comprising introducing the process gas at a flow rate of from about 1 to about 10 sccm.

14. A process chamber comprising:
(a) a substrate support in a process zone;
(b) a gas distributor to introduce a process gas into a gas ionization zone, the gas ionization zone being above the process zone;
(c) a gas ionizer to couple energy to the process gas in the gas ionization zone to ionize the process gas;
(d) an ion filter to form ion beams from the ionized gas in the gas ionization zone and introduce the ion beams into the process zone;
(e) an ion filter power supply to apply a voltage bias to the ion filter; and
(f) an exhaust conduit to exhaust spent process gas from the chamber.

15. A chamber according to claim 14 wherein the gas ionizer comprises a pair of ionizer electrodes about the gas ionization zone or an inductor coil encircling the process chamber.

16. A chamber according to claim 14 wherein the gas ionizer comprises a pair of spaced apart and electrically conducting wire grids that each have openings.

17. A chamber according to claim 16 wherein the wire grids comprise a ratio of the total area of the openings of any one of the grids to the total area covered by the solid portions of the same wire grid that is from about 10:1 to about 1000:1.

18. A chamber according to claim 16 wherein the gas distributor comprises a gas distribution plate having apertures, and wherein at least one wire grid is mounted on a gas distribution plate such that the openings in the mounted wire grid coincide with the apertures in the gas distribution plate.

19. A chamber according to claim 14 comprising an electron source to inject electrons into the process zone.

20. A chamber according to claim 19 wherein the electron source comprises a wire filament through which a current can be passed to heat the wire filament to eject electrons from the wire.
